(19) United States
(12) Patent Application Publication
(10) Pub. No.: US 2009/0034390 A1
(43) Pub. Date: Feb. 5, 2009

(54) OPTICAL INFORMATION RECORDING MEDIUM AND DRAWING METHOD THEREFOR

(75) Inventors: Hidenori Somei, Gunma (JP); Satoshi Kobayashi, Gunma (JP); Ippei Maekawa, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd., Tokyo (JP)

(21) Appl. No.: 12/035,364

(22) Filed: Feb. 21, 2008

(30) Foreign Application Priority Data
Feb. 21, 2007 (JP) 2007-040871

(51) Int. Cl. G11B 7/00; B32B 3/02

(52) U.S. Cl. 369/100; 428/64.8; G9B/7

(57) ABSTRACT

An optical information recording medium capable of being drawn without being overturned by an optical information recording apparatus and cable of being drawn not depending on the wavelength of a laser light to be irradiated, the optical information recording medium having an information recording portion in which a recording layer and a first reflection layer are formed successively on a first substrate, and having a drawing portion in which a second reflection layer, a color-change layer, a color-change assistance layer, and a protection layer are formed successively on a second substrate, in which the second reflection layer is heated by irradiation of a laser light and the material in the color-change layer and the material in the color-change assistance layer are melted by the heat and mixed to cause a color change thereby forming images.

### BACKGROUND OF THE INVENTION

1. Field of the Invention

The present invention relates to an optical information recording medium such as DVD±R having a structure capable of being drawn by laser irradiation and drawing method therefor.

2. Description of Related Art

An optical information recording medium such as a write-once type CD (CD-R), a write-once type DVD±R, or a write-once type blue-ray disc (BD-R) has a structure in which a recording layer and a reflection layer are formed on a light transparent substrate with a diameter of 12 cm or 8 cm. Among them, CD-R has a structure in which a recording layer and a reflection layer are formed on a light transparent substrate of about 1.2 mm thickness. DVD±R has a structure in which a recording layer and a reflection layer are formed on a light transparent substrate of about 0.6 mm thickness. This is because a laser light of a shorter wavelength and an object lens of a large number of aperture (NA) have been adopted for attaining a higher density recording and, accordingly, it has become necessary to increase the tolerance of tilt of a disc. Therefore, for aligning the thickness with that of CD-R, DVD±R is formed by bonding substrates of an identical shape having about 0.6 mm thickness to each other. Further, for attaining a further higher density recording, BD-R has a structure in which a reflection layer and a recording layer are formed successively on a light incident surface of a light transparent substrate of about 1.1 mm thickness, and then a light transparent layer of about 0.1 mm thickness is formed.

In the optical information recording medium described above, the surface of the substrate opposite to the incident side of a laser light for recording is usually utilized as a label surface and letters, symbols, graphs, patterns, or combinations thereof, for example, are printed thereon. Further, a printable layer is sometimes disposed on the surface opposite to the incident side of a laser light such that images or letters can be printed by an ink jet printer or the like.

In such an optical information recording medium, while images or letters can be formed easily by printing on the label surface, equipment used exclusively therefor or equipment capable of coping therewith is necessary for conducting the printing. Then, a technique of drawing by a laser light on a labeled surface of an optical information recording medium by using an optical information recording apparatus has been proposed recently. For example, Japanese Unexamined Patent Application (“JP-A”) No. 2006-031882 proposes an optical information recording medium formed with a region on a label surface capable of being drawn (“drawing layer”) by laser irradiation, which enables drawing by using the optical information recording apparatus.

However, since the drawing layer is present on the opposite surface to the incidence surface of a recording laser light in JP-A No. 2006-031882, it is necessary to overturn the optical information recording medium upon drawing. Further, dyes are used for the drawing layer in JP-A No. 2006-031882, and since the decomposition properties of dyes depend on the wavelength of a laser light to be irradiated, it is necessary to provide dyes with decomposition properties conforming to the wavelength of the recording laser light.

### SUMMARY OF THE INVENTION

The present invention intends to provide an optical information recording medium capable of being drawn without being overturned by an optical information recording apparatus and without depending on the wavelength of a laser light to be irradiated.

The present invention provides, as an embodiment, an optical information recording medium having an information recording portion formed in the order of a recording layer and a first reflection layer on one surface of a light transparent first substrate, and further having a drawing portion capable of recording visible information on the side of the surface formed with the information recording portion, in which the first reflection layer is a partial-transparent reflection layer, the drawing portion has a second reflection layer, a drawing layer, and a protective layer in the order from the side of the information recording portion, and the drawing layer has a color-change layer in which visible information is recorded and, a color-change assistance layer containing a material for changing the color of the color-change layer. Herein, “color change” means the change of optical properties (such as reflection, absorption, and deflection of light) and includes, for example, “discoloration” in which absorption of light decreases to make the color pale, or “color extinction” in which color is lost. Further, “light transmittance” means herein a light transmittance of 70% or more and, more preferably, 80% or more when measured by a spectrophotometer. Further, the visible information means herein information that can be read with the naked eyes such as images, letters, symbols, patterns, etc.

A first embodiment of an optical information recording medium of the present invention functions as described below. At first, since the first reflection layer in the information recording portion is a partial-transparent reflection layer, this allows a drawing laser light to transmit therethrough. The drawing laser light transmitting through the first reflection layer is irradiated to the second reflection layer in the drawing portion. By focusing the drawing laser light on the second reflection layer, the second reflection layer is heated by the spot of the drawing laser light. When the heat from the second reflection layer is conducted to the drawing layer, a material constituting the color-change layer and a material constituting the color-change assistance layer are melted by heat to be mixed. The color-change layer undergoes a color change by the action. Then, visible information such as images is recorded due to the color change of the color-change layer.

According to the first embodiment of the invention, the following effects can be expected. That is, since the drawing laser light can be irradiated from the same direction with that of the recording laser light, the visible information can be recorded by the optical information recording apparatus without being overturned. Further, as it may suffice that the drawing laser light can heat the drawing layer, there is no need of particular requirement for restricting the wavelength of the laser light, which enables an increase in the degree of freedom for selecting the laser light wavelength while considering the conditions for the information recording layer, for example. Further, since for the material of the color-change layer, it is not necessary to use those having decomposition properties conforming to the wavelength of the recording laser light, it becomes possible to conduct drawing independent of the wavelength of the irradiated laser light.

Further, the present invention provides, as a second embodiment, an optical information recording medium as in the first embodiment, wherein the second reflection layer is a partial-transparent reflection layer. The optical information recording medium of the second embodiment functions as described below. That is, when a portion of the drawing laser light is irradiated to the second reflection layer, the second reflection layer is heated. On the other hand, since the second reflection layer is a partial-transparent reflection layer, a portion of the drawing laser light is transmitted through the second reflection layer and is irradiated directly to the color-change layer. The drawing laser light having reached the color-change layer and the color-change assistance layer heats the color-change layer and the color-change assistance layer. Since this allows indirect heating from the second reflection layer and direct heating to the color-change layer to be utilized, the time from the irradiation of the drawing laser light to the heat melting of the color-change layer and the color-change assistance layer can be shortened and the drawing speed can be increased.

In this case, the effect of the invention can be achieved more efficiently when a material that generates heat upon irradiation of the drawing laser light is present in the color-change layer and the color-change assistance layer.

Therefore, as a third embodiment, the present invention proposes an optical information recording medium as in the second embodiment which contains a material that generates heat by the irradiation of the laser light in the color-change layer and the color-change assistance layer. Accordingly, the color-change layer and the color-change assistance layer can be melted by the heat generation of the second reflection layer and the heat generation of the color-change layer and the color-change assistance layer, thereby enabling visible information such as images to be recorded in the drawing portion.

Further, the present invention provides, as a fourth embodiment, an optical information recording medium as in the first embodiment or the second embodiment, wherein the drawing layer has the color-change layer and the color-change assistance layer in this order from the side nearer to the second reflection layer. The visible information is formed mainly in the color-change layer and, particularly, tends to be formed at the boundary between the color-change layer and the color-change assistance layer. According to the optical information recording medium of the fourth embodiment, since the color-change layer is present at a position nearer to the second reflection layer, heat from the second reflection layer is conducted to the color-change layer prior to the color-change assistance layer. Accordingly, the color-change layer is first melted by the heat and then the boundary between the color-change layer and the color-change assistance layer undergoes a color change. Then, since the boundary between the color-change layer and the color-change assistance layer is located on the side of the label surface of the color-change layer, the visible information recorded in the drawing portion is easy to see.

Further, the present invention provides, as a fifth embodiment, an optical information recording medium as in the first embodiment or the second embodiment, wherein the thickness of the drawing layer is decreased in the layer nearer to the second reflection layer out of the color-change layer and the color-change assistance layer. According to the fifth aspect of the invention, the heat from the second reflection layer to conducted more easily from the layer nearer to the second reflection layer to the layer remote from the second reflection layer. Accordingly, the color-change layer and the color-change assistance layer are reliably melted by the heat to be mixed.

Further, the invention provides, as a sixth embodiment, an optical information recording medium as in the first embodiment or the second embodiment, wherein an interlayer is formed between the color-change layer and the color-change assistance layer in the drawing layer. The interlayer has a function of preventing the materials contained in the color-change layer and the color-change assistance layer from being in contact with each other so as not to cause a color change before the recording of visible information. Further, it has a function of controlling the degree of mixing of the color-change layer and the color-change assistance layer during the recording of the visible information.

Further, the invention provides, as a seventh embodiment, an optical information recording medium as in the first embodiment or the second embodiment, wherein a light transparent second substrate is bonded by way of an adhesive layer on the surface of the first substrate with the information recording portion, and the drawing portion is formed on the surface of the second substrate opposite to the surface bonded with the information recording portion. According to the seventh embodiment of the invention, since the information recording portion and the drawing portion are separated by the second substrate, it is possible to achieve an optical information recording medium the drawing portion of which can be drawn with no interference to the image recording portion.

Further, the invention provides, as an eighth embodiment, an optical information recording medium as in the first embodiment or the second embodiment, wherein the drawing portion is formed including the drawing layer and the second reflection layer in this order on one surface of a light transparent second substrate, and the surface formed with the drawing portion and the surface of the first substrate formed with the information recording portion are bonded by way of an adhesion layer. According to the eighth embodiment of the invention, since the second substrate can be used as a protective layer, it is possible to provide an optical information recording medium capable of being drawn without being overturned by an optical information recording apparatus at a low cost.

Further, the invention provides, as a ninth embodiment, an optical information recording medium in the second embodiment, wherein the drawing portion is formed adjacent with the information recording portion, and the first reflection layer and the second reflection layer use a partial-transparent reflection layer in common. According to the ninth embodiment of the invention, since one layer may suffice for the partial-transparent reflection layer, an optical information recording medium capable of being drawn without being overturned by an optical information recording apparatus can be obtained at a low cost.

Further, in addition to the ninth embodiment, a light transparent second substrate may be bonded by way of an adhesive layer to the surface of the first substrate with the information recording portion and the drawing portion. Since in this arrangement the second substrate functions as a protective layer, the drawing portion can be protected.

Further, the invention provides, as a tenth embodiment, an optical information recording medium having an information recording portion including a first reflection layer and a recording layer in this order on one surface of a light transparent first substrate, in which the first reflection layer is a partial-transparent reflection layer; a light transparent cover layer being formed on the recording layer of the information recording portion; and having a drawing portion capable of recording visible information on the other surface of the first substrate, in which the drawing portion has a second reflection layer, a drawing layer, and a protective layer in this order from the side of the first substrate, and in which the drawing layer has a color-change layer to which visible information is recorded and a color-change assistance layer containing a material for changing the color of the color-change layer. According to the tenth embodiment, since the information recording portion is formed on one surface of the first substrate, and the drawing portion is formed on the other surface of the first substrate, the information recording portion and the drawing portion are isolated by the first substrate and this can provide an optical information recording medium capable of drawing to the drawing portion without interference to the information recording portion.

Further, the invention provides a drawing method of recording visible information to an optical information recording medium having an information recording portion formed including a recording layer and a first reflection layer in this order from the incident side of a recording laser light on one surface of a light transparent first substrate; and having a drawing portion formed including a second reflection layer, a drawing layer, and a protective layer in the order from the incident side of a recording laser light at a position opposite to the incident side of the recording laser light to the information recording portion, in which the drawing layer includes a color-change layer for recording visible information and a color-change assistance layer containing a material that changes the color of the color-change layer; wherein the method includes irradiating a drawing laser light on the drawing portion from the direction identical with the recording laser light, focusing the light on the second reflection layer, heating and melting the color-change layer and the color-change assistance layer, and mixing the material constituting the color-change layer and the material constituting the color-change assistance layer to cause a color change, thereby recording visible information. The drawing method is a method of heating the second reflection layer by the drawing laser light and heating the color-change layer and the color-change assistance layer by the heat. Since it may suffice that the drawing laser light can heat the second reflection layer, a laser light of any wavelength can be used. As a result, drawing is possible independent of the wavelength of the irradiated laser light.

Further, in this case, irradiation of the recording laser light to the information recording portion and irradiation of the drawing laser light to the drawing portion may be conducted simultaneously. Since the drawing laser light does not depend on the wavelength, a laser light from a light source different from that of the recording laser light can be used. This makes it possible to conduct data recording to the information recording portion and recording of the visible information to the drawing portion simultaneously. As a result, the total recording time for the data recording and the recording for the visible information can be shortened compared with existent optical information recording medium.

According to the invention, since the drawing laser light can be irradiated on the side identical with that of the recording laser light, drawing to the drawing portion can be carried out by an optical information recording apparatus without overturning the optical information recording medium. Further, since it is not necessary to use materials having decomposition properties conforming with the wavelength of the recording laser light as the material for the drawing layer, it is possible to obtain an optical information recording medium capable of being drawn not depending on the wavelength of the irradiated laser light.

### BRIEF DESCRIPTION OF THE DRAWINGS

FIG. 1 is a schematic fragmentary cross sectional view showing an embodiment of an optical information recording medium of the invention;

FIG. 2 is a schematic fragmentary cross sectional view enlarging the portion surrounded with a dotted line C in FIG. 1;

FIG. 3 is a schematic fragmentary cross sectional view enlarging the portion surrounded with the dotted line C in FIG. 1, which shows a state of forming a color-change portion HS.

FIG. 4 is a schematic fragmentary cross sectional view enlarging the portion surrounded with the dotted line C in FIG. 1, which shows a case where a second reflection layer is a partial-transparent reflection layer.

FIG. 5 is a schematic fragmentary cross sectional view enlarging the portion surrounded with the dotted line C in FIG. 1, which shows a case where the thickness is different between a color-change layer and a color-change assistance layer.

FIG. 6 is a schematic fragmentary cross sectional view showing another embodiment of an optical information recording medium of the invention;

FIG. 7 is a schematic fragmentary cross sectional view showing still another embodiment of an optical information recording medium of the invention;

FIG. 8 is a schematic fragmentary cross sectional view showing another example of still another embodiment of the optical information recording medium of the invention;

FIG. 9 is a schematic fragmentary cross sectional view showing yet another embodiment of an optical information recording medium of the invention.

### PREFERRED EMBODIMENTS OF THE INVENTION

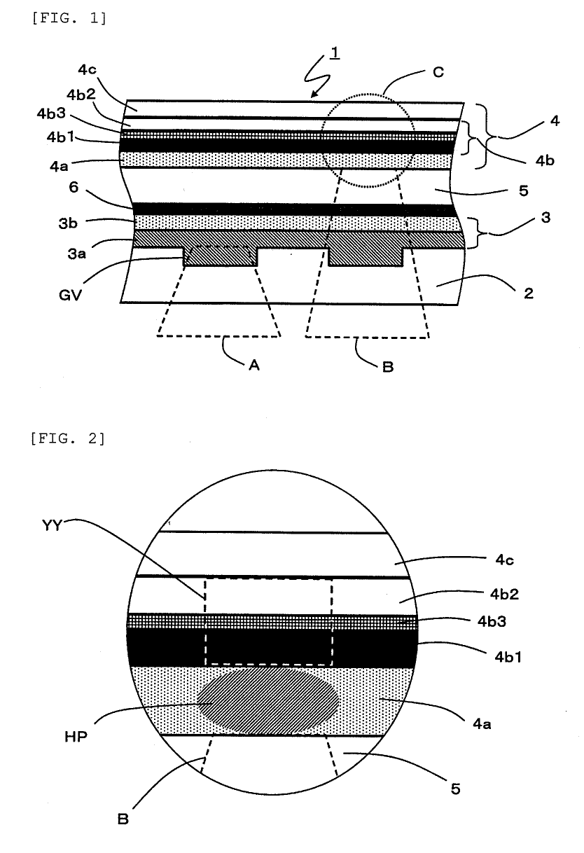

An embodiment of an optical information recording medium of the invention is to be described with reference to FIG. 1 to FIG. 5. FIG. 1 is a schematic fragmentary cross sectional view of an optical information recording medium of the embodiment of the invention, showing an example of DVD±R. An optical information recording medium 1 has an information recording portion 3 in which a recording layer 3a and a first reflection layer 3b are formed successively on the surface of a light transparent first substrate 2 opposite to the incident surface of a recording laser light A; a light transparent second substrate 5 bonded by way of an adhesive layer 6 to the surface of the first substrate 2 with the information recording portion 3; and a drawing portion 4 in which a second reflection layer 4a, a drawing layer 4b, and a protective layer 4c are formed successively on the surface of the second substrate 5 opposite to the incident surface of the recording laser light A. The drawing layer 4b has a color-change layer 4b1, a color-change assistance layer 4b2, and an interlayer 4b3 formed between the color-change layer 4b1 and the color-change assistance layer 4b2. A dotted line A denotes a recording laser light and a dotted line B denotes a drawing laser light. A spiral guide groove GV is formed on the first substrate 2 to be used for tracking or positional information detection upon recording or reproduction.

The first substrate 2 is formed of a light transparent resin such as a polycarbonate and formed into a disk-like substrate having about 120 mm diameter, about 0.6 mm thickness, and a through hole of about 15 mm diameter (not illustrated) at the center by injection molding or the like. The guide groove GV is formed by a stamper set in a mold upon injection molding. The recording layer 3a is a layer containing an organic dye and formed by coating a dye such as an azo dye or a cyanine dye dissolved, for example, in a TFP (tetrafluoro propanol) solution by spin coating. Recording to the recording layer 3a is conducted by irradiating a recording laser light A of a wavelength of about 630 nm to about 680 nm to form pits. The first reflection layer 3b is a partial-transparent reflection layer (half-transparent, for example) for allowing the drawing laser light B to pass therethrough. As the material constituting the first reflection layer 3b, a dielectric multi-layer film formed by laminating metals (Ag, Ag based alloy, Al, for example) or oxide films of different refractive indexes may be used. The first reflection layer 3b may be formed by depositing such materials to a thickness of about 10 to about 100 nm by sputtering or CVD. The second substrate 5 is in a shape substantially identical with that of the first substrate 2, comprised of a light transparent resin such as a polycarbonate, and may be molded by injection molding into a disk-like substrate having about 120 mm diameter and about 0.6 mm thickness, and a through hole (not illustrated) of about 15 mm diameter at the center. While the guide groove is not shown as being formed in the second substrate 5 in FIG. 1, the guide groove may be formed so as to detect the positional information for drawing. The second substrate 5 is bonded by way of an adhesive layer 6 so as to oppose the surface of the first substrate 2 with the information recording portion 3. The adhesive layer 6 may comprise a light transparent curable resin, for example an epoxy type adhesive or the like.

The second reflection layer 4a is a layer that generates heat by irradiation of the drawing laser light B. Since the second reflection layer 4a functions as a heat generation layer, it is preferably formed of a metal with a lower reflectivity than usual reflection layers that totally reflect light. Such a reflection layer may be obtained by depositing a metal such as Ag, Al, Ti, W and alloys thereof, for example, to a thickness of about 10 to about 130 nm by sputtering or CVD. Ti, with less heat diffusion, is preferred. The second reflection layer 4a may also be a partial-transparent reflection layer like the first reflection layer 3b. In this case, the constituting material may be a material identical with that for the first reflection layer 3b. In a case of forming the second reflection layer 4a as a partial-transparent reflection layer, the drawing laser light B passes the second reflection layer 4a and is irradiated also to the drawing layer 4b.

The drawing layer 4b comprises the color-change layer 4b1, the color-change assistance layer 4b2, and the interlayer 4b3. Recording of visible information to the drawing layer 4b is conducted by heat-melting a material constituting the color-change layer 4b1 and a material constituting the color-change assistance layer 4b2 and mixing them to cause a color change. A color change may include color formation, discoloration, or color extinction. In a case of color formation, the color-change layer 4b1 is a layer containing a color former and the color-change assistance layer 4b2 is a layer containing a color developer. In a case of discoloration or color extinction, the color-change layer 4b1 is a layer including a mixture of a color developer and a color former and the color-change assistance layer 4b2 is a layer containing a material for inhibiting an interaction between the color developer and the color former contained in the color-change layer 4b1. The melting points of the color-change layer 4b1 and the color-change assistance layer 4b2 may be about 80° C. to about 200° C., preferably about 100° C. to about 180° C., respectively. In FIG. 1 and in the succeeding drawings, the color-change layer 4b1, the interlayer 4b3, and the color-change assistance layer 4b2 are arranged in this order from the side nearer to the second reflection layer 4a. The order may be reversed. That is, the color-change assistance layer 4b2, the interlayer 4b3, and the color-change layer 4b1 may be arranged in this order successively from the side nearer to the second reflection layer 4a. In a case where the color change is color formation, any arrangement may be used, but in a case where the color-change is discoloration or color extinction, since the color-change layer 4b1 exhibits color, an arrangement in which the color-change portion is on the side of the label surface of the color-change layer 4b1 is preferred because the visible information is not concealed by the color-change layer 4b1. In any of the cases, it is preferred that a layer remote from the second reflection layer 4a is light transparent.

The color former may include leuco dyes, for example, those having a fluoran skeleton such as 3-isopentyl ethylamino-6-methyl-7-anilino fluoran, 3-dipentylamino-6-methyl-7-anilino fluoran, 3-diethylamino-6-methyl-7-anilino fluoran, 3-diethylamino-7-(m-trifluoromethyl anilino) fluoran, or 3-dibutylamino-6-methyl-7-anilino fluoran. The layer containing the color former may obtained by forming a film of such a leuco dye dissolved in a solvent such as TFP by spin coating.

The color developer forms a color by interaction with the leuco type dye described above. Specific materials thereof include, for example, phenol compounds such as 4,4′-dihydroxy diphenyl sulfone, 2,4′-dihydroxydiphenyl sulfone, 4-hydroxy-4′-isopropoxydiphenyl sulfone, bis(3-allyl-4-hydroxyphenyl)sulfone, benzyl p-hydroxy benzoate, and dehydration polycondensates of polycondensates of 2,2′-bis(hydroxymethyl)-1,3-propane diol and 4-hydroxy benzoic acid. The layer containing the color developer may be obtained by dissolving the phenol compound into a solvent such as butanol and forming a film by spin coating. In a case where the color change is discoloration or color extinction, the color-change layer 4b1 may be obtained by forming a film from a mixture of a color former and a color developer, for example a mixture of a leuco dye+TFP+phenol compound+butanol by spin coating.

Material for inhibiting the interaction between the color developer and the color former may include those of hydrocarbon polymers attached with hetero atoms and not having acidity. Specific materials include, for example, polymethyl methacrylate, polyvinyl alcohol, polyethylene glycol, ethyl cellulose, chitin and chitosan. In a case of discoloration or color extinction, the color-change assistance layer 4b2 may be obtained by dissolving the materials in a solvent, for example an alcohol, and forming a film by spin coating.

The interlayer 4b3 has a role of preventing the color-change layer 4b1 and the color-change assistance layer 4b2 from contacting each other so as not to cause a color-change before recording visible information. For this purpose, in a case where the color-change layer 4b1 and the color-change assistance layer 4b2 are formed of materials not causing a color change by mere contact to each other, the interlayer 4b3 may be omitted. Further, the interlayer 4b3 also has a function that it is broken during the recording of visible information to provide a state that the material of the color-change layer 4b1 and the material of the color-change assistance layer 4b2 can be in contact and mixed to each other. The state of breakage can be controlled by selecting the thickness of the interlayer 4b3 or the hardness of the constituent material. Then, the state of mixing between the color-change layer 4b1 and the color-change assistance layer 4b2 can be controlled by the state of breakage of the interlayer 4b3. The material constituting the interlayer 4b3 may include Al, In, Ag, Ti, or SiO₂ and the interlayer can be obtained by forming a film to a thickness of about 5 to about 20 nm by sputtering or CVD.

When the second reflection layer 4a is formed as a partial-transparent reflection layer, the drawing laser light B is directly irradiated to the drawing layer 4b. Accordingly, a material that generates heat by the irradiation of the drawing laser light B may be mixed so that heat is generated in the color-change layer 4b1 and the color-change assistance layer 4b2. As the material that generates heat by the irradiation of the laser light, organic dye materials or metal particles of aluminum, titanium, tungsten, silicon or germanium are preferred.

The protective layer 4c has a function of protecting the drawing layer 4b against humidity or the like. It is necessary that the protective layer 4c is heat resistant and moisture resistant, as well as transmissive of visible light since the layer is present outside the drawing layer 4b in which the visible information is recorded. The material used for the protective layer 4c includes, for example, polycarbonates or acrylic resins. The protective layer 4c may be formed by bonding a light transparent resin sheet with an adhesive layer (not illustrated), or by coating and curing a curable resin by spin coating or screen printing.

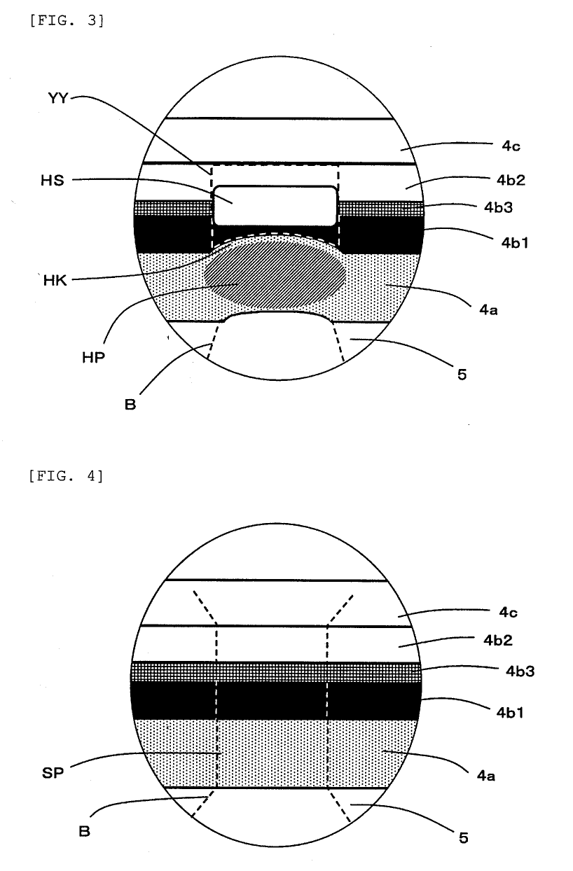

A method of conducting drawing to the optical information recording medium 1 constituted as described above is to be described with reference to FIG. 1 to FIG. 3. Description is made, as an example of an embodiment, to a case where the second reflection layer 4a is not a light transparent reflection layer, the color-change layer 4b1 is a mixed layer of a leuco dye and a phenol compound, and the color-change assistance layer 4b2 is formed of polymethyl methacrylate (PMMA). The drawing laser light B is irradiated from the direction identical with the recording laser light A. Since the first reflection layer 3b is a partial-transparent reflection layer, the drawing laser light B is irradiated so as to pass through the first reflection layer 3b and to be focused on the second reflection layer 4a. In this case, as shown in FIG. 2, the second reflection layer 4a is heated by the spot of the drawing laser light B to form a heat generation portion HP. The heat from the heat generation portion HP is conducted to the color-change layer 4b1.

The color-change layer 4b1 exhibits a black color by the interaction between the leuco dye and the phenol compound. When the heat from the heat generation portion HP is conducted, the color-change layer 4b1, the color-change assistance layer 4b2, and the interlayer 4b3 are heated. In this case, when the temperature reaches a melting point, a molten portion YY is formed, and the color-change layer 4b1 and the color-change assistance layer 4b2 are liquefied. Then, as shown in FIG. 3, the second reflection layer 4a heated by the drawing laser light B deforms by thermal expansion to form a deformed portion HK. The deformed portion HK protrudes in the direction of the relatively soft drawing portion 4b. The deformed portion HK exerts a pressure on the mixture of the molten leuco dye and the phenol compound of the color-change layer 4b1. Then, the interlayer 4b3 is broken to cause a turbulence flow and the molten mixture of the leuco dye and the phenol compound of the color-change layer 4b1 and the molten PMMA of the color-change assistance layer 4b2 are mixed. In the portion where mixing occurred, interaction between the leuco dye and the phenol compound is inhibited by PMMA. As a result, a color-change portion HS is formed where black color vanished and which appears colorless or white. Visible information is formed in the drawing portion 4 by the contrast between the color-change portion HS and a portion with no color-change.

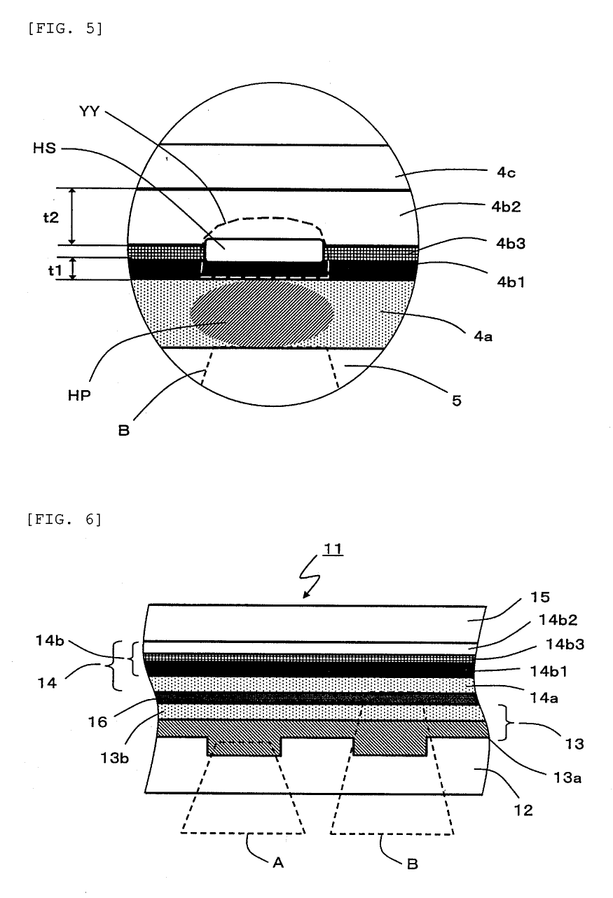

Description is now made, as an example of an embodiment, to a case where the second reflection layer 4a is a partial-transparent reflection layer with reference to FIG. 4. When the drawing laser light B is irradiated so as to be focused on the second reflection layer 4a, the second reflection layer 4a is heated by the spot SP of the drawing laser light B. At the same time, the drawing laser light B passes through the second reflection layer 4a and is irradiated to the drawing layer 4b. In this case, the spot SP of the drawing laser light B forms a beam waist (depth of focus). The thickness of the beam waist is determined by the wavelength of the irradiated laser light and the number of aperture of the lens and represented by λ/(NA)² (in which λ represents the wavelength of an irradiated laser light and NA represents the number of aperture of a lens). By the phenomenon, the spot SP of the drawing laser light B having passed the second reflection layer 4a reaches as far as the drawing layer 4b. By the spot SP, the heat generating materials in the color-change layer 4b1 and the color-change assistance layer 4b2 are heated and the drawing layer 4b generates heat directly. According to this method, the color-change portion HS can be formed in a shorter time than by the method of conducting heat by the heating of the second reflection layer 4a and thus the drawing time can be shortened.

In the optical information recording medium 1 as described above, since the information recording portion 3 and the drawing portion 4 are isolated by the second substrate 5, they do not interfere to each other. Further, since a laser light of any wavelength may be used for the drawing laser light B, a laser light of a wavelength identical with or different from that of the recording laser light A irradiated to the information recording portion 3 may be used. Accordingly, by the use of a recording and reproducing apparatus having plural laser light sources referred to as a multi-drive, data recording to the information recording portion 3 and the recording of the visible information to the drawing portion 4 can be conducted simultaneously.

Further, as shown in FIG. 5, the thickness t1 of the color-change layer 4b1 nearer to the second reflection layer 4a may be made less than the thickness t2 of the color-change assistance layer 4b2 remote from the second reflection layer 4a. With such a constitution, since the heat from the heat generation portion HP can be transferred easily to the color-change assistance layer 4b2 remote from the second reflection layer 4a, the molten portion YY can reach reliably the color-change assistance layer 4b2. In a case where the layer nearer to the second reflection layer 4b2 is the color-change assistance layer 4b2, the same effect can be obtained also by making the thickness of the color-change assistance layer 4b2 less than the thickness of the color-change layer 4b1.

Then, another embodiment of an optical information recording medium of the invention is to be described with reference to FIG. 6. An optical information recording medium 11 shown in FIG. 6 is an example of DVD±R different from that of the first embodiment described above. It has an information recording portion 13 including a recording layer 13a and a first reflection layer 13b formed successively on the surface of a light transparent first substrate 12 opposite to the incident surface of a recording laser light A; and has a drawing portion 14 including a color-change assistance layer 14b2, an interlayer 14b3, a color-change layer 14b1, and a second reflection layer 14a formed successively on the incident surface of the recording laser light A of a light transparent second substrate 15, in which the surface of the first substrate 12 with the information recording portion 13, and the surface of the second substrate 15 formed with the drawing portion 14 are bonded by way of an adhesive layer 16. The drawing method or the like is identical with that in the first embodiment described above, and the drawing laser light B is irradiated so as to pass through the first substrate 1, the recording layer 13a, the first reflection layer 13b, and the adhesive layer 16 and to be focused on the second reflection layer 14a.

As described above, in the optical information recording medium 11, since the second substrate 15 can be used as a protective layer, the cost can be decreased by that much. Further, since forming the information recording portion 13 on the first substrate 12 and forming the drawing portion 14 on the second substrate 15 can be conducted separately, the processing time can be shortened compared with a case of forming them successively in one step.

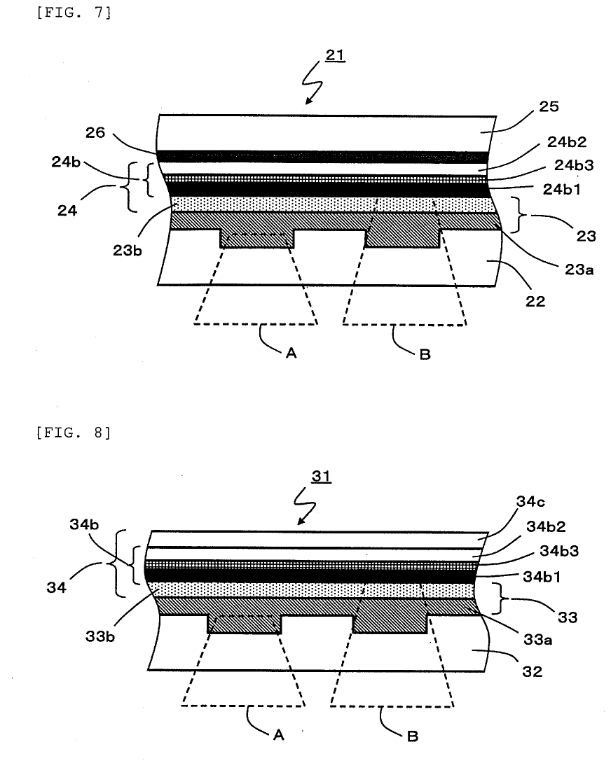

Then, another embodiment of an optical information recording medium of the invention is to be described with reference to FIG. 7. An optical information recording medium 21 shown in FIG. 7 shows an example of DVD±R different from that of the first embodiment described above. It has an information recording portion 23 including a recording layer 23a and a first reflection layer 23b formed successively on the surface of a light transparent first substrate 22 opposite to the incident surface of the recording laser light A; a drawing portion 24 thereabove including a color-change layer 24b1, an interlayer 24b3, and a color-change assistance layer 24b2 formed successively; and a light transparent second substrate 25 bonded by way of an adhesive layer 26 to the surface of the first substrate 22 with the information recording portion 23 and the drawing portion 24. The drawing method or the like is identical with that of the first embodiment described above, and the drawing laser light B is irradiated so as to pass through the first substrate 22 and the recording layer 23a and to be focused on the first reflection layer 23b.

The optical information recording medium 21 described above has a feature that the first reflection layer 23b of the information recording portion 23 is used in common as the reflective layer of the drawing portion 24. Since an expensive apparatus for sputtering or CVD is often used to form a reflection layer, the production cost usually increases by that much. However, in the structure of this embodiment, since it may suffice that the reflection layer is formed only by one layer, an optical information recording medium capable of being drawn by an optical information recording apparatus without being overturned can be obtained at a low cost. In such a structure, while the information recording portion 23 and the drawing portion 24 are formed adjacent with each other compared with the first and the second embodiments described above, the influence caused therefrom can be decreased when the wavelength of the recording laser light A to be irradiated to the information recording portion 23 is made different from that of the drawing laser light B to be irradiated to the drawing portion 24. Further, as to the influence of the heat generation of the reflection layer 23b on the recording layer 23a, since the temperature necessary for the color change of the color-change layer 24b is from about 80° C. to about 180° C., which is lower than the decomposition temperatures of dyes (about 250° C. or higher) used generally for an optical information recording medium, there are no problems.

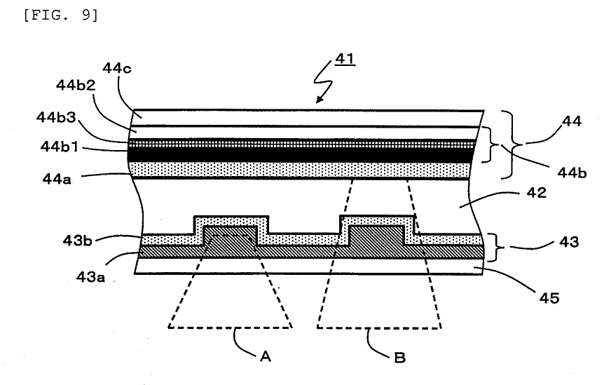

Further, as another example of a preferred embodiment, an optical information recording medium 31 is shown in FIG. 8. This has the same structure with that of CD-R, and has an information recording portion 33 including a recording layer 33a and a first reflection layer 33b formed successively on the surface of a light transparent first substrate 32 of about 1.2 mm thickness opposite to the incident surface of the recoding layer light A; and has thereabove a drawing portion 34 including a color-change layer 34b1, an interlayer 34b3, a color-change assistance layer 34b2, and a protective layer 34c formed successively. In the structure, the first reflection layer 33b may be either a partial-transparent reflection layer or a usual reflection layer causing total internal reflection.

Then, another embodiment of an optical information recording medium of the invention is to be described with reference to FIG. 9. An optical information recording medium 41 shown in FIG. 9 shows an example of the structure of BD-R. It has an information recording portion 43 including a first reflection layer 43b and a recording layer 43a formed successively from the surface of the substrate on the incident surface of the recording laser light A of a light transparent first substrate 42, with a light transparent cover layer 45 being formed on the recording layer 43a of the information recording portion 43; and has a drawing portion 44 including a second reflection layer 44a, a color-change layer 44b1, an interlayer 44b3, a color-change assistance layer 44b2, and a protective layer 44c formed successively from the surface of the substrate on the surface of the first substrate 42 opposite to the incident surface of the recording laser light A. Further, although not illustrated, a light transparent protective layer may also be formed between the recording layer 43a and the cover layer 45. Further, the drawing method or the like is identical with that for the first embodiment described above. The drawing laser light B is irradiated so as to pass through the cover layer 45, the recording layer 43a, the first reflection layer 43b, and the first substrate 42 and to be focused on the second reflection layer 44a.

The first substrate 42 may be formed of a light transparent resin such as a polycarbonate and molded into a disk substrate having about 120 mm diameter, about 1.1 mm thickness and a through hole of about 15 mm diameter at the center (not illustrated) by a method such as injection molding. The recording layer 43a may be a layer containing an organic dye and formed by coating a dye such as an azo dye or cyanine dye dissolved, for example, into a TFP solution by spin coating. Recording to the recording layer 43a is conducted by irradiating a recording laser light A of a wavelength of about 400 nm to about 450 nm to form pits. Further, the cover layer 45 may be formed of a light transparent resin of about 0.1 mm thickness, and can be obtained by bonding a sheet of a polycarbonate of about 0.1 mm thickness with a light transparent adhesive layer (not illustrated), or coating a light transparent UV-curable resin by spin coating or the like and curing the same to form a film of about 0.1 mm thickness. Further, the first reflection layer 43b, the second reflection layer 44a, the color-change layer 44b1, the color-change assistance layer 44b2, the interlayer 44b3, and the protective layer 44c may be identical with those of the first embodiment described above.

In the optical information recording medium 41 as described above, since the information recording portion 43 is formed on one surface of the first substrate 42 and the drawing portion 44 is formed on the other surface of the first substrate 42, they are isolated by the first substrate 42 and do not interfere with each other. Further, since the focal distance differs greatly between the recording laser light A and the drawing laser light B in a case of BD-R, separate light sources are used. Accordingly, data recording to the information recording portion 43 and recording of visible information to the drawing portion 44 can be conducted simultaneously by a recording and reproducing apparatus having a plurality of laser light sources, referred to as a multi-drive.

While the invention has been described with respect to preferred embodiments, the invention is also applicable to other optical information recording medium, with no restriction to the shape thereof or the like, within the scope of the invention.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. An optical information recording medium comprising:
an information recording portion comprising a recording layer and a first reflection layer formed in this order on a first surface of a light transparent first substrate; and
a drawing portion, capable of recording visible information, on the first surface,
wherein the first reflection layer is a partial-transparent reflection layer;
wherein the drawing portion comprises a second reflection layer, a drawing layer, and a protective layer in this order from the side of the first surface, and
wherein the drawing layer comprises a color-change layer on which visible information is recorded and a color-change assistance layer containing a material that changes the color of the color-change layer.

2. An optical information recording medium according to claim 1, wherein the second reflection layer is a partial-transparent reflection layer.

3. An optical information recording medium according to claim 2, wherein the color-change layer and the color-change assistance layer contain a material that generates heat by the irradiation of a laser light.

4. An optical information recording medium according to claim 1, wherein the color-change layer and the color-change assistance layer are formed in this order from the second reflection layer.

5. An optical information recording medium according to claim 1, wherein the thickness of whichever of the color-change layer or the color-change assistance layer is nearer to the second reflection layer is smaller than the other of the two layers.

6. An optical information recording medium according to claim 1, wherein an interlayer is formed between the color-change layer and the color-change assistance layer in the drawing layer.

7. An optical information recording medium according to claim 1, wherein a light transparent second substrate is bonded by way of an adhesive layer to the first surface of the first substrate, and the drawing portion is formed on the surface of the second substrate opposite to the surface bonded with the first surface of the first substrate.

8. An optical information recording medium according to claim 1, wherein the drawing layer and the second reflection layer of the drawing portion are formed in this order on a first surface of a light transparent second substrate, and the first surface thereof and the first surface of the first substrate are bonded by way of an adhesive layer.

9. An optical information recording medium according to claim 2, wherein the drawing portion is formed adjacent with the information recording portion, and a partial-transparent reflection layer is used in common as the first reflection layer and the second reflection layer.

10. An optical information recording medium according to claim 9, wherein a light transparent second substrate is bonded by way of an adhesive layer to the first surface of the first substrate.

11. An optical information recording medium according to claim 1, further comprising an interlayer between the color-change layer and the color-change assistance layer.

12. An optical information recording medium comprising:
an information recording portion formed in the order of a first reflection layer and a recording layer on a first surface of a light transparent first substrate, with a light transparent cover layer being formed on the recording layer of the information recording portion; and
a drawing portion capable of recording visible information on a second surface of the first substrate,
wherein the first reflection layer is a partial-transparent reflection layer,
the drawing portion is formed in the order of a second reflection layer, a drawing layer, and a protective layer from the side of the first surface, and
wherein the drawing layer comprises a color-change layer in which the visible information is recorded and a color-change assistance layer containing a material that changes the color of the color-change layer.

13. A drawing method of recording visible information to an optical information recording medium comprising an information recording portion formed in the order of a recording layer and a first reflection layer from the incident side of a recording laser light on a first surface of a light transparent first substrate; and a drawing portion formed in the order of a second reflection layer, a drawing layer, and a protective layer from the first surface on the surface opposite to the incident side of the recording laser light to the information recording portion, wherein the drawing layer includes a color-change layer in which visible information is recorded, and a color-change assistance layer containing a material that changes the color of the color-change layer, wherein the method comprises:
irradiating a drawing laser light to the drawing portion from the direction identical with that of the recording laser light, focusing the drawing laser light to the second reflection layer, heating and melting the color-change layer and the color-change assistance layer, and mixing a material constituting the color-change layer and a material constituting the color-change assistance layer to cause a color change thereby recording visible information.

14. A drawing method of an optical information recording medium according to claim 13, wherein irradiation of the recording laser light to the information recording portion and irradiation of the drawing laser light to the drawing portion are conducted simultaneously

15. A drawing method of an optical information recording medium according to claim 13, wherein the recording laser light and the drawing laser light are the same laser light.

16. A drawing method of an optical information recording medium according to claim 13, wherein the recording laser light and the drawing laser light are different laser lights.
